(19) United States
(12) Patent Application Publication
(10) Pub. No.: US 2021/0108459 A1
(43) Pub. Date: Apr. 15, 2021

(54) Threat Detection and Security Entryway System

(71) Applicant: Mooring Point, LLC, Toledo, OH (US)

(72) Inventors: Jamie A. M. O'Brien, La Salle, MI (US); John Sheehan, Lambertville, MI (US); Marie Emily Roy, St. Louis, MO (US); Sajid A. Khan, Toledo, OH (US)

(73) Assignee: Mooring Point, LLC, Toledo, OH (US)

(21) Appl. No.: 16/970,542

(22) PCT Filed: Feb. 19, 2019
(86) PCT No.: PCT/US19/18655

§ 371 Date: Aug. 17, 2020

Related U.S. Application Data
(60) Provisional application No. 62/710,388, filed on Feb. 16, 2018.
(60) Provisional application No. 62/632,346, filed on Feb. 19, 2018.
(60) Provisional application No. 62/632,340, filed on Feb. 19, 2018.

(51) Int. Cl. E06B 5/10; E06B 3/90; E06B 3/36; E05C 1/00; E05F 15/70

(52) U.S. Cl. CPC E06B 5/10; E06B 3/90; E06B 3/36; E05C 1/006; E05Y 2900/132; E05Y 2201/694; E05Y 2400/45; E05Y 2400/44; E05F 15/70

(57) ABSTRACT

An entryway system has at least one door having access hardware on both sides. The access hardware on both sides each have a first handing position that operates a latch and a second handing position that prevents latch operation. In response to a sensed condition, such as a trigger from a metal detector or other sensing device, one or both of the access hardware can be selectively re-handed from the first handing position to the second handing position.

### CROSS-REFERENCE TO RELATED APPLICATIONS

This application claims the benefit of United States Provisional Application No. 62/710,388, filed Feb. 16, 2018; U.S. Provisional Application No. 62/632,340, filed Feb. 19, 2018; and U.S. Provisional Application No. 62/632,346, filed Feb. 19, 2018; the disclosures of which are incorporated herein by reference in their entirety.

### BACKGROUND OF THE INVENTION

This invention relates in general to threat detection systems used in conjunction with entrance and exit devices and, in particular, to metal detection systems coupled to building doorway systems. This invention further relates to ingress and egress structures that can respond to identification of a potential threat and isolate or eject the detected threat perpetrator(s) prior to entry into an interior space or other sensitive area.

Doors and locking systems have been used for centuries to protect spaces from intrusion and threats. During the early part of the 1900s considerations of building egress during emergencies, such as fire, changed how doorway systems were viewed for public buildings. Several large scale building disasters resulting in the loss of significant human life led to changes in building codes and the design of doorways, particularly in public buildings. One such change requires that exit doors open toward the outside of a building so that the door itself does not become an obstacle to egress in an emergency.

Security concerns have heightened in recent decades because of terrorist activities intended to inflict maximum damage and loss of life to innocent bystanders. Scanning for weapons, explosives, or other contraband has been utilized to screen entry into potential target facilities, such as government buildings, airports, and other popular, high profile public locations. One drawback with the current methods of threat detection in many public buildings is that the potential threat is typically allowed access to a building prior to scanning for weapons. This interior scanning permits entrances to remain unobstructed and ready as exits in the event of an emergency. In places where scanning is done prior to entry, such as arenas and large outdoor venues, the visitors are forced to remain outside during the inspection process. Such a condition poses problems for both visitors and security, particularly during inclement weather conditions. Where scanning for threat detection has been coupled to entryways, typically a person is permitted to enter an intermediate area—a security vestibule—for scanning prior to entry into the final destination, such as a bank lobby. The security vestibule is defined by an unlocked door facing the exterior and a locked door providing entry into the interior lobby. A metal detector is located in the vestibule and visitors are required to pass through the detector. The exterior door closes behind a visitor and locks to the outside to prevent unintended threats to enter after scanning has begun. The interior door is unlocked by a clean scan permitting entry to the building interior. A person in this intermediate location can leave if a scan has failed or if entry is not desired. These systems, however, actuate locking mechanisms to prevent or permit passage. As such, these systems can malfunction thereby trapping a visitor within the security vestibule, particularly where dedicated entrance and exit lanes are used. What would be desirable is an entrance system that can permit exit from a security vestibule to either a building interior, a security zone or a building exterior without reliance on actuating locking mechanisms for entry and exit purposes.

### SUMMARY OF THE INVENTION

This invention relates to threat detection systems used in conjunction with entrance and exit devices and, in particular, to metal detection systems coupled to building doorway systems. This invention further relates to ingress and egress structures that can respond to identification of a potential threat and isolate or eject the detected threat perpetrator(s) prior to entry into an interior space or other sensitive area.

This invention provides a continuous means of egress, while providing the ability to block ingress in a moving door system should security personnel deem it necessary.

This invention relates to an apparatus and a method for a tool to detect metal object(s) by measuring the interference caused by the object on electromagnetic wave transmission. The interference of electromagnetic waves by metal objects is well known, but by using multiple transmitters and an array of receivers in a specific geometric arrangement, this interference can be used to identify the metal object's location and shape, and track its motion. In its preferred embodiment as a security scanner, multiple transmitters will pulse electromagnetic waves at specific frequencies within a designated area, which is surrounded by an array of hundreds of receivers/transponders. Spikes of signal reflected by metal objects will be digitally processed to determine the 3D location, shape, and composition of any metal object detected, compare the data collected to a database, and classify anomalies as benign or as a possible threat. The software will generate an image of the object's shape and superimpose the image on a video monitor, directing security personnel to pat down the person if needed. Identification of authorized personnel could be done simultaneously by placing tags on ID cards and badges.

This invention further relates to an apparatus and a method for a tool to detect metal object(s) by measuring the interference caused by the object on electromagnetic wave transmission. In its preferred embodiment as a hallway-mounted security scanner, multiple transmitters can pulse electromagnetic waves at specific frequencies within a designated area, which is surrounded by an array of receivers/transponders. Any metal object(s) carried by a person walking through the hallway will present a leading edge that reflects electromagnetic waves in several directions. As the leading edge is tracked, additional scan data will help processing software determine the anomaly's 3D location and size/shape, for comparison to a database of known items. Security personnel will then be alerted to investigate any potential threat identified. When used in conjunction with the entry and exit door of the present invention, the door handing is changed to permit exit based on the relative position of the door to the entry opening of the building.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a perspective view of an embodiment of a conveyor door and scanning system in accordance with the invention.

FIG. 2 is a door having a door hardware member in the form of a touch bar with a re-handing system in accordance with the invention.

FIG. 3A is a latch pin and actuator assembly having a re-handing mechanism in accordance with the invention.

FIG. 3B is the latch pin and actuator assembly of FIG. 3A with a slide housing portion removed.

FIG. 4A is a side view of the upper section of the door of FIG. 2 showing the touch bar in a first handing position.

FIG. 4B is the touch bar and re-handing mechanism of FIG. 4A.

FIG. 5 is an exploded view of the upper door and touch bar assembly of FIG. 4A.

FIG. 6A is another exploded view of the latch pin and actuator assembly, similar to FIG. 4B, having the re-handing mechanism.

FIG. 6B is an exploded perspective view of another aspect of the latch pin, actuator and re-handing assembly of FIG. 6A.

FIG. 7A is an elevational view of the re-handing assembly of FIGS. 6A and 6B.

FIG. 7B is a plan view of the re-handing assembly of FIG. 7A.

FIG. 7C is an exploded view of the re-handing assembly of FIG. 7A.

FIG. 8 is another embodiment of a re-handing mechanism having a pneumatic or hydraulic actuator.

FIG. 9 is another embodiment of a re-handing mechanism having a magnetic and/or electromagnetic actuator.

FIG. 10 another embodiment of a re-handing mechanism having a mechanically driven actuator, in the form of a rack-and-pinion drive.

FIG. 11A is an enlarged view of a reaction support end of the re-handing mechanism of FIGS. 6A and 6B with a support plate removed.

FIG. 11B is an exploded view of the reaction support end of the re-handing mechanism of FIG. 11A.

FIG. 12A is an enlarged view of the trigger actuation end of the re-handing mechanism of FIG. 6A.

FIG. 12B is an exploded view of the trigger actuation end of the re-handing assembly of FIG. 12A.

FIG. 13 is an alternative embodiment of an electronic trigger for the re-handing mechanisms of FIGS. 9-11.

FIG. 14 is a door pivot assembly and portion of the door frame.

FIGS. 15A and 15B are cross section views, one in elevation and one in perspective, of the door pivot assembly of FIG. 14.

FIG. 15C is a cross sectional view of a pivot arm slide member of FIG. 14.

FIG. 15D is a cross section view of a door pivot support of the door pivot assembly of FIG. 14.

FIG. 16A is an exploded view of a door and the door pivot assembly of FIG. 14 in accordance with the invention.

FIG. 16B is an enlarged, cross sectional view of the door frame, door latch bar, and door pivot assembly of FIG. 16A.

FIG. 17A is the integrated and assembled view of the door and pivot assembly of FIG. 14.

FIGS. 17B-17D illustrate the door pivot assembly of FIG. 14 in a closed position (FIG. 17B), a mid-swing position (FIG. 17C), and an open position (FIG. 17D).

FIGS. 18A-18E illustrate the operation of doors having a latching and re-handing actuator assembly applied to a conveyor-type revolving door structure in accordance with the invention.

FIG. 19A illustrates a subject entering the conveyor-type revolving door structure of FIG. 18A.

FIG. 19B illustrates the subject being moved to a scanning area of the conveyor-type revolving door structure of FIG. 19A.

FIG. 20 illustrates a circularly revolving door having a re-handing door assembly in accordance with the invention.

FIG. 21 illustrates a swinging hinged door having a re-handing door assembly in accordance with the invention.

### DETAILED DESCRIPTION OF THE PREFERRED EMBODIMENT

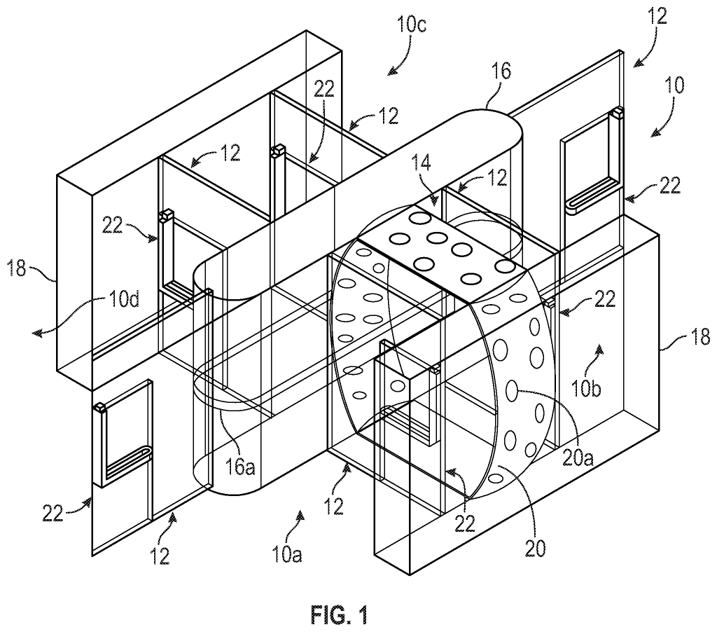

Referring now to the drawings, there is illustrated in FIG. 1 a threat detection and security entryway system, shown generally at 10, and configured as a conveyor entryway. The entryway system 10 defines an entry direction, such as into a building entry, starting at a pre-security entrance 10a into the system 10 and a post-security exit 10b, permitting entry into the building interior or secured space. The system further defines a building or security exit 10c and a system exit 10d. In the illustrated embodiment, the exits 10c and 10d do not show a security detection device, though one may be provided. The entryway system 10 includes a plurality of partitioning elements, shown generally at 12 that move along a central conveyor 16 and cooperate to define a security vestibule 14 therebetween. The central conveyor 16 includes a handing trigger 16a. As will be discussed below in detail, the handing trigger 16a signals for a re-handing manipulation of the door hardware at one or more positions along the conveyor path. The handing trigger 16a may be configured as a mechanical trigger, an electronic trigger, a magnetic trigger, or any other type of triggering mechanism to signal that the door hardware handing should change from one state to another.

The security vestibule 14 is defined by two adjacent partitioning elements 12, the central conveyor 16, and an outer entryway wall 18. Similarly, the vestibule 14 of the exit side is likewise defined. The vestibule 14, particularly the entrance vestibule 14 includes a threat detection system, shown generally at 20. The threat detection system 20 may include one or more of a metal detection device, RFID scanner, a facial recognition device, a x-ray device, an optical retinal scanner, a finger print analyzer, a weight measurement device, or other mechanical or biometric analysis tool, symbolized by a plurality of scanning sensors 20a associated with one or more of the specific detector methods. Each partitioning element 12 includes a door closure structure, shown generally at 22. In certain embodiments, the partitioning element 12 may be configured only as a door closure structure, such as door closure structure 22. While the door closure structure is shown in FIG. 1 as of predominantly glass construction, the door closure structure may be formed of any suitable materials, including metal, wood, glass, composites, or any combination thereof.

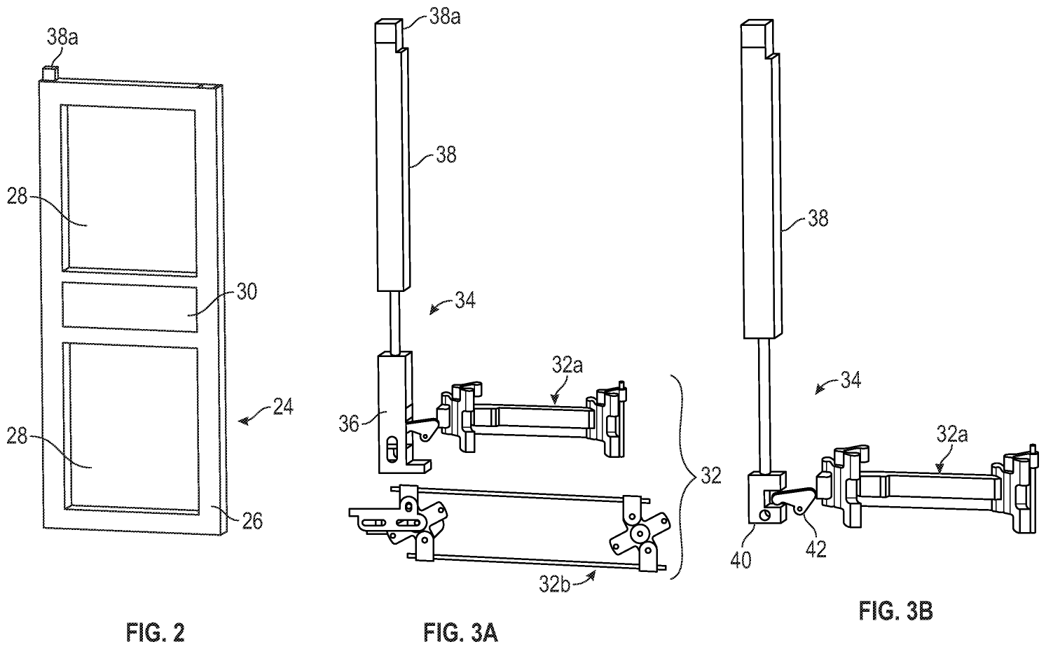

Referring to FIGS. 2-5, there is illustrated an embodiment of a door closure structure 24 (or “door” as a shorthand reference), that is similar to and a suitable alternative of the glass embodiment, door closure structure 22 of FIG. 1. The door 24 is illustrated to have a frame 26 and one or more optional panels 26, which may be configures as solid panels or windows, though such is not required. The frame 24 supports a touch bar 30 having a latch actuation and re-handing mechanism, shown generally at 32, that is moveable towards and away from the door plane to actuate a latching mechanism, shown generally at 34. Though shown and described in the context of a touch bar (or crash bar), the doors 22, 24 may be opened by other access hardware such as door knobs, door handles, door pulls or other hardware that can be handed to an actuation position to open a door or a non-actuation position to prevent opening the door. The latch actuation and re-handing mechanism 32 includes a latch actuator portion 32a and a re-handing mechanism portion 32b. The re-handing mechanism portion 32b is connected by a linkage arrangement 32c, shown schematically, to the touch bar 30. The re-handing mechanism 32b responds to inputs of the handing trigger 16a to move the latch actuator 32a from a first handing position to a second handing position. In the illustrated embodiment, the latching mechanism 34 includes a slide housing 36, a latch pin or latch bar 38, and a receiver 40. The latch bar 38 terminates in a bolt 38a for engagement with a striker (not shown) that is formed as part of the supporting structure of the door, as will be described below. A toggle lever 42 engages the receiver 40 in order to transfer motion from the touch bar actuation mechanism 32 to the latch bar 38.

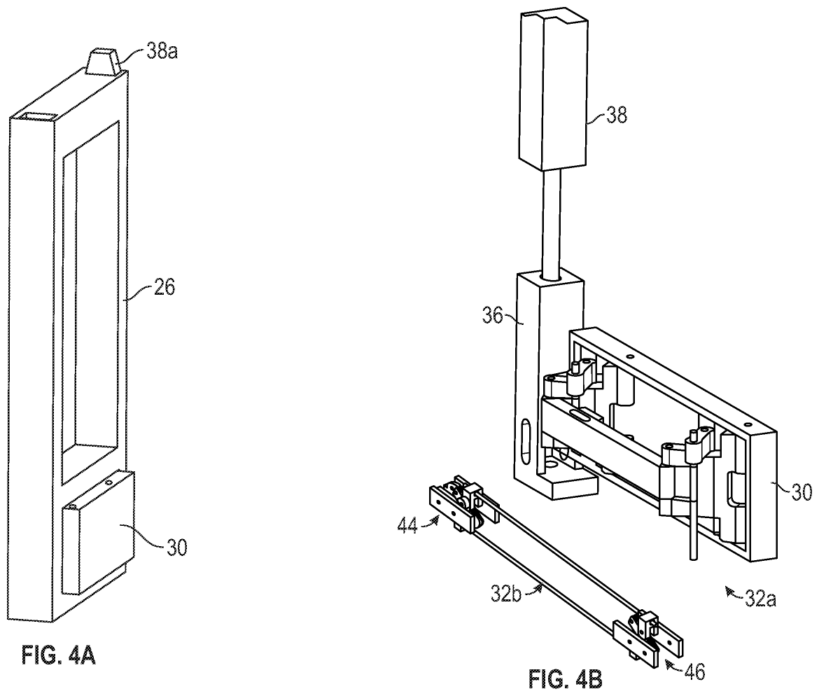

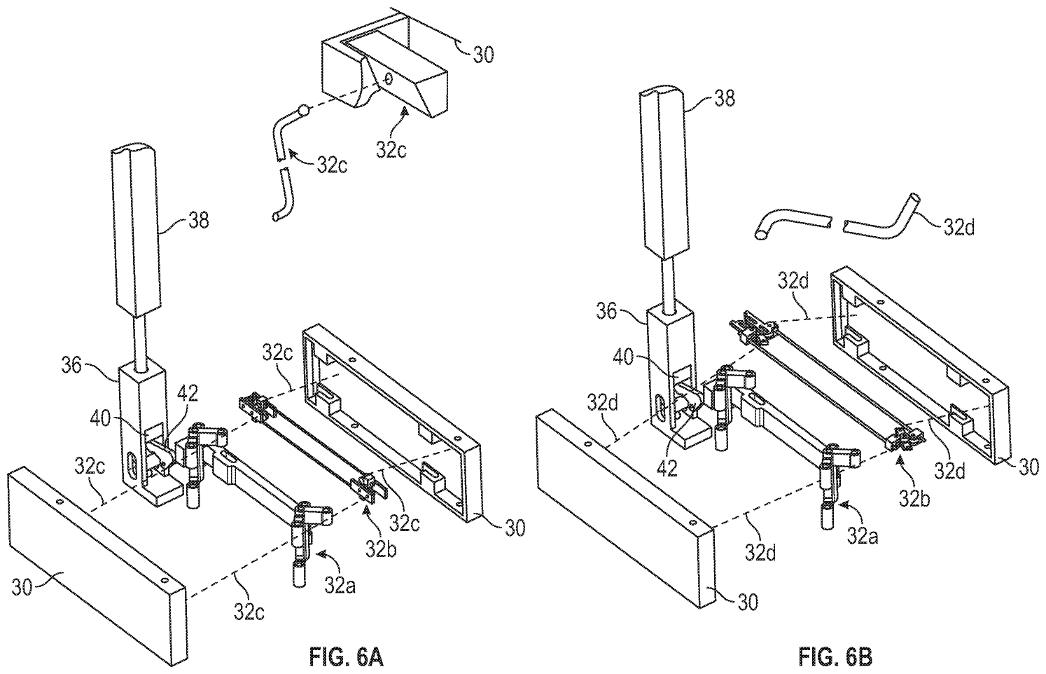

The re-handing mechanism 32b provides the ability to change handing of the hardware during movement of the panels 12 or door 24 around the conveyor 16, dependent upon the position of the door (or partition) in the rotation sequence prior to opening or access of the security vestibule 14 into the building interior. The handing of a door system, for example having touch bar and hardware arrangement 30 and 32a, presents one touch bar, such as touch bar 30, in an actuation position, as shown in FIG. 4A, which may extend from the surface of the door 24. In the illustrated embodiment showing the mechanically triggered re-handing mechanism 32b, a trigger actuation end 44 and a reaction support end 46. The other touch bar, shown in FIGS. 6A and 6B, is presented in a non-actuation or displaced position which may be flush with the surface of the door 24 or otherwise placed in an inoperative condition (electrically or mechanically).

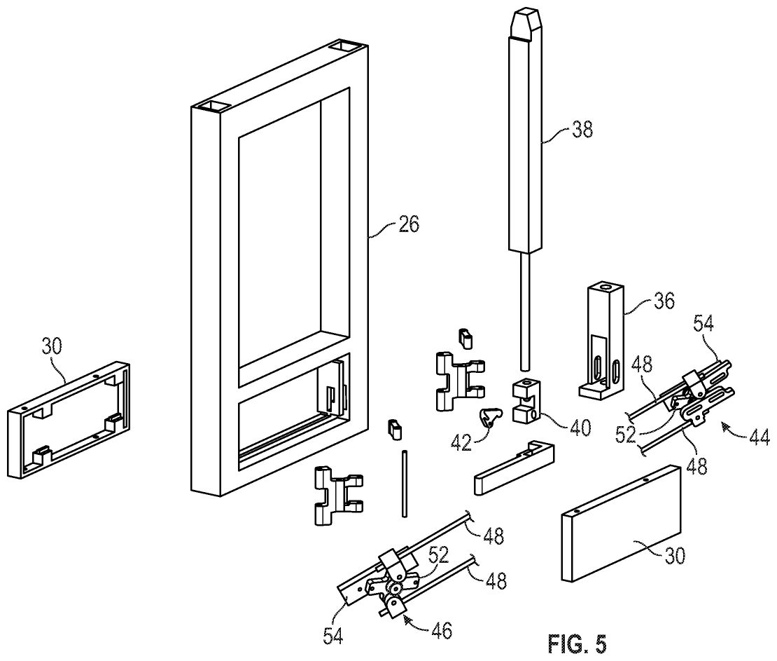

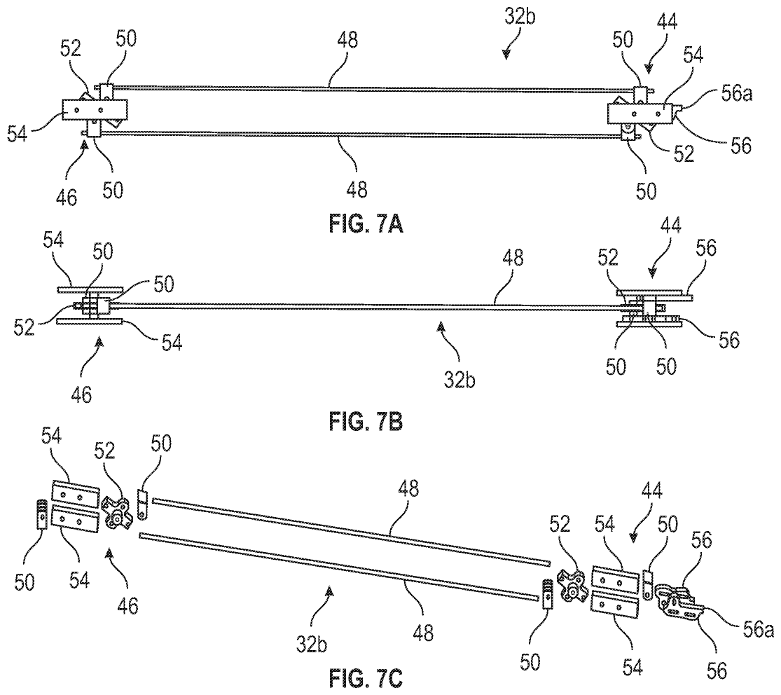

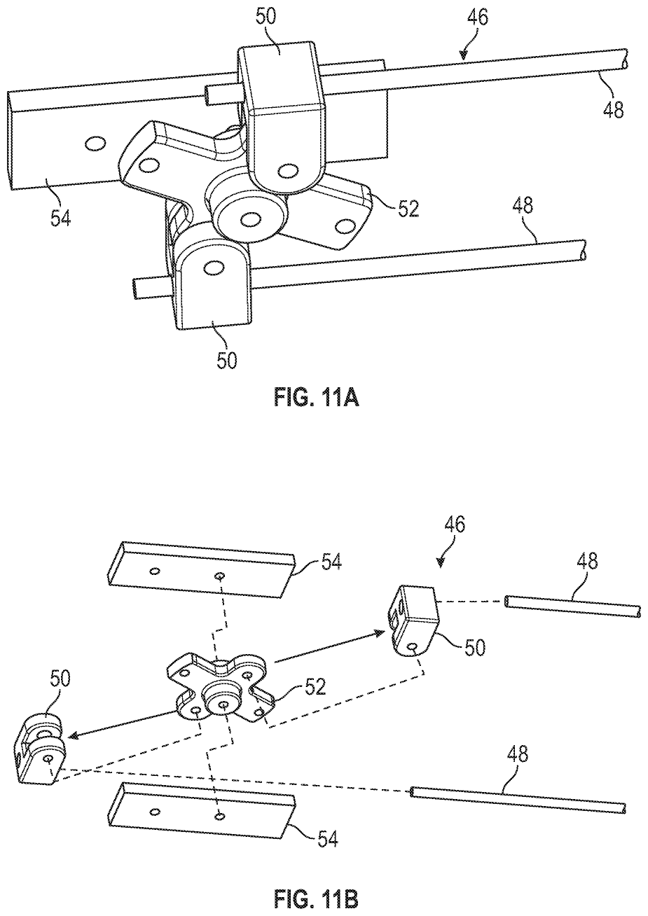

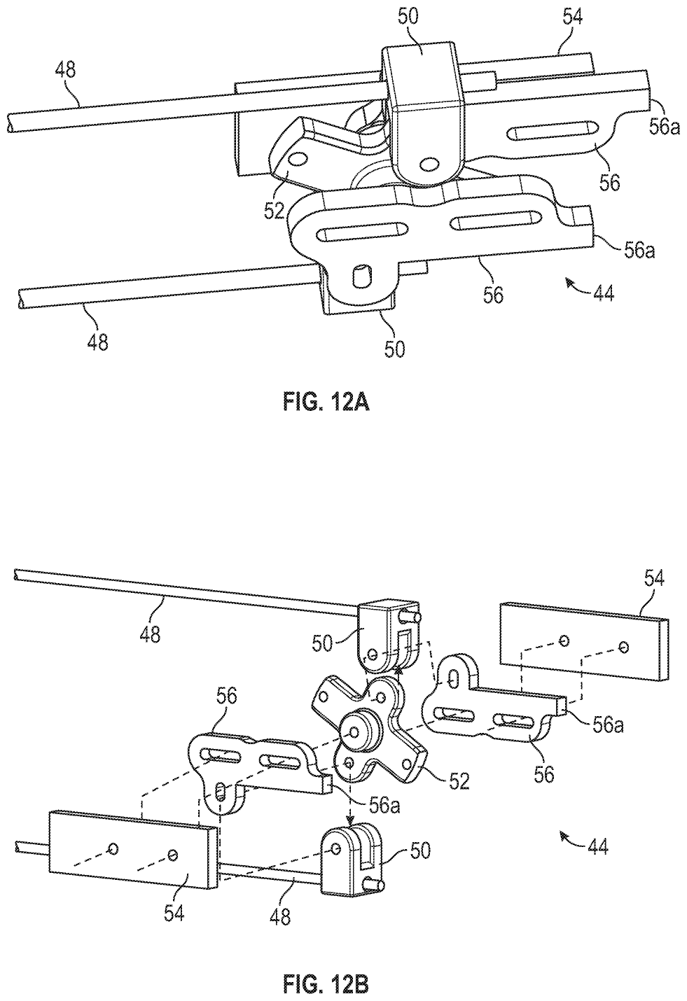

Referring now to FIGS. 5-7C and 11A-12B, the trigger actuation end 44 and the reaction support end 46 of the re-handing mechanism 32b include at least one transfer rod 48, two are shown, connected by pivot blocks 50 at each end to a transfer hub 52. The transfer hubs 42 rotate relative to mounting plates 54, which may be separate components or integrated as part of the door frame 26 or hardware mounting structure that supports the touch bars 30 and the latch actuation portion 32a relative to the door. Though shown as a cross-shaped structure, the transfer hub 42 may be any suitable geometric shape. The linkage 32c transfers the rotational motion of the transfer hubs 52 to motion causing the touch bar 30 to assume one of the actuation or non-actuation positions. In one embodiment, the re-handing mechanism 32b may be oriented with rods 48 vertically positioned and the linkage 32c may be configured as sliding tapers and interconnecting rods that draw in or push out the touch bars 30 relative to the door to provide the actuation and non-actuation positions. In another embodiment, the re-handing mechanism 32b may be oriented with rods 48 horizontally positioned and a linkage 32d may be rods that operatively connect the re-handing mechanism 32b to the touch bars 30 to provide the actuation and non-actuation positions. In yet another embodiment, the re-handing mechanism 32b may be connected to the latch actuator 32a, which in turn is connected to the touch bars 30. The trigger actuation end 44 further includes a trigger receiver 56, shown as a pair of spaced-apart trigger receivers that interact with the handing trigger 16a.

In the embodiment illustrated in FIGS. 5-7C and 12A-12B, the interaction of the handing trigger 16a and the trigger receivers 56 is mechanical, similar to a cam and follower arrangement. The handing trigger 16a has two generally parallel tracks that are offset in sections to actuate the re-handing mechanism 32b and change the handing of the touch bars 30 depending on the position of the doors relative to the ingress, egress and scanner portions of the entryway. In the illustrated embodiment, the trigger receivers 56 are configured similarly and mounted inversely such that contact tips 56a are offset relative to the different triggering sections of the handing trigger 16a. The trigger receivers 56 are mounted such that the contact tip 56a of one trigger receiver 56 is in contact with a first portion of the handing trigger 16a to cause one of the touch bars 30 to be moved to the actuation position and the other touch bar to be moved to the non-actuation position. A second portion of the handing trigger 16a permits the other trigger receiver 56 to move in consort with the actuated trigger receiver 56. As the first and second tracks of the handing trigger 16a alternate orientations based on the door positions relative to the exits and entrances, the trigger receivers 56 move likewise such that the handing orientation of the touch bars 30 are changed. The changes in handing orientation of the touch bars 30 can permit exit from the entryway system 10 prior to entering the scanning area or during scanning (if a threat is detected). Further, the handing can be oriented so that in the event of an emergency, such as a fire, both sides of the entryway system, can function as exits to permit the quickest flow of people fleeing from the interior space.

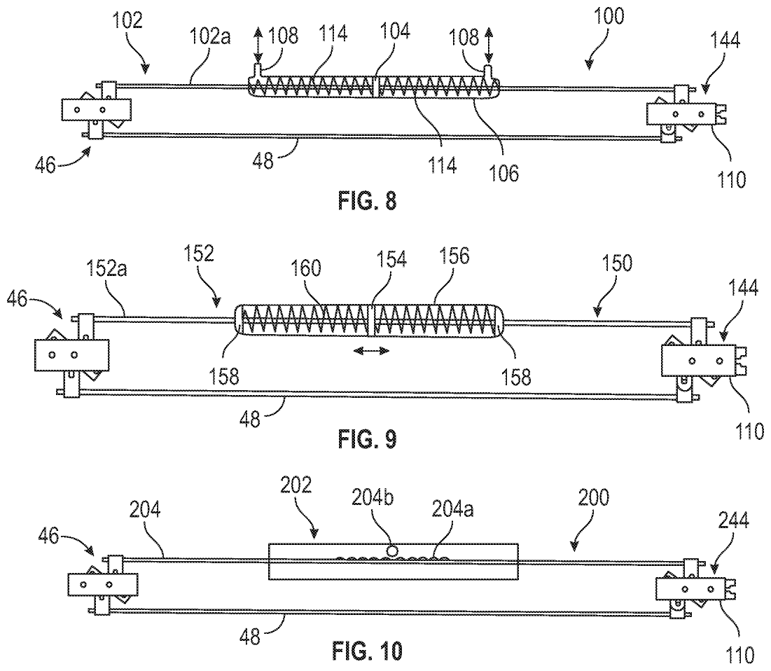

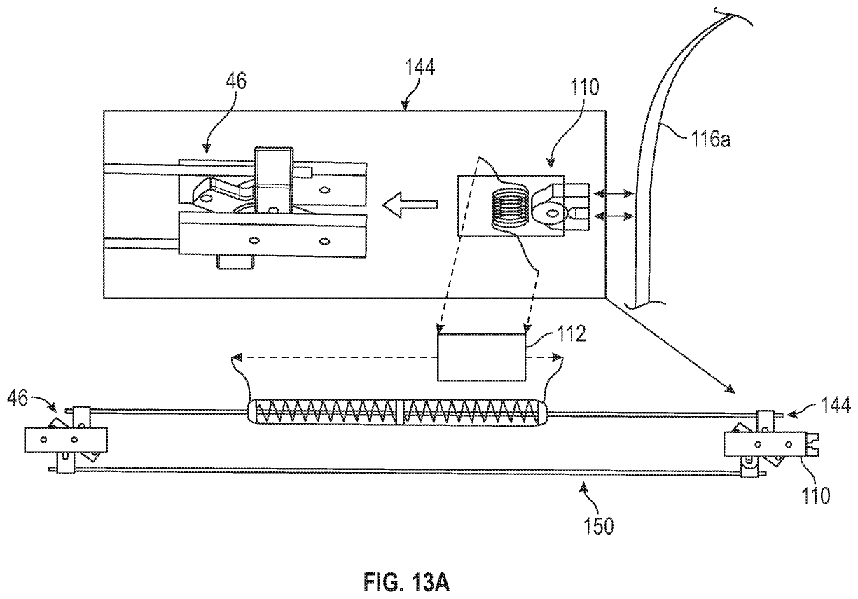

Referring now to FIGS. 8-10 and 13, there are illustrated alternative embodiments of re-handing mechanisms that utilize an electronic sensor to trigger movement of the touch bar 30 into either the actuation position or the non-actuation position. A re-handing mechanism 100 includes a pneumatically or hydraulically driven rod 102. The rod portion 102a, similar to rod 48, includes a piston 104 positioned within a cylinder 106. The re-handing mechanism 100 includes the reaction end 46 and a trigger actuation end 144. The trigger actuation end 144 includes a support configured similarly to the reaction end 44 and further includes a sensor 110, that electronically performs a similar function to the trigger receivers 56. Electronically controlled inlet/outlet valves 108 permit fluid entry and exit based on signals from the sensor 110 interacting with an electronic handing trigger 116a. The electronic handing trigger 116a may be any type of transmitting device, analog or digital, that produces a signal received by the sensor 110. A controller 112 may be provided to actuate the valves 108, as required to re-hand the touch bars 30. The valves may be provided as normally-open valves and one or more springs 114 may be positioned on either side of the piston 104 such that in a power outage condition the valves open to permit free fluid flow and the springs position the piston in a neutral position where both touch bars 30 on either side of the door or partition are in the actuation position.

As shown in FIG. 9, an alternative embodiment of a re-handing mechanism 150 includes a magnetic or linear motor drive 152 to drive rod 152. Secured to rod 152 is a magnetically responsive piston 154 positioned within a housing 156 that supports spaced apart electromagnets 158. The re-handing mechanism 150 further includes the reaction end 46 and the trigger actuation end 144 with the sensor 110. Springs 160, similar to springs 114, may be provided to position the re-handing mechanism 150 in the neutral position. As described above, the electromagnets 158 may be energized through the controller 112 in response to the sensor 110 interacting with the handing trigger 116a.

FIG. 10 illustrates another embodiment of a re-handing mechanism 200 having an electro-mechanical drive configured as a rack-and-pinion actuator 202. Rod 204 includes a rack section 204a having gear teeth that are driven by a pinion 204b coupled to an electric drive motor. The drive motor may be operated in either rotational direction in response to signals between the sensor 110, the controller 112, and the handing trigger 116a. In the illustrated embodiment, the re-handing mechanism 200 includes the reaction end 46, rod 48, and a trigger actuation end 244 having the sensor 110 and a biasing spring to bias the re-handing mechanism 200 into the neutral position in the event of a power loss.

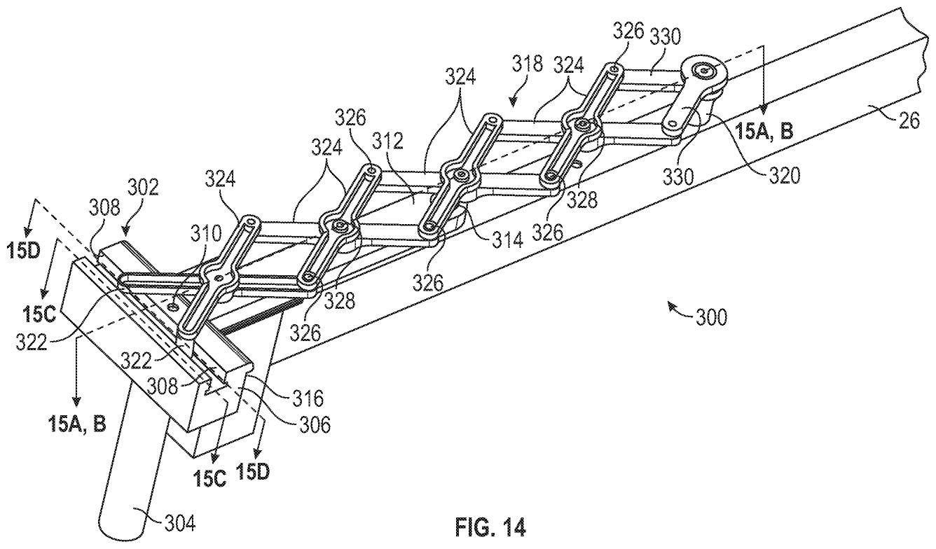

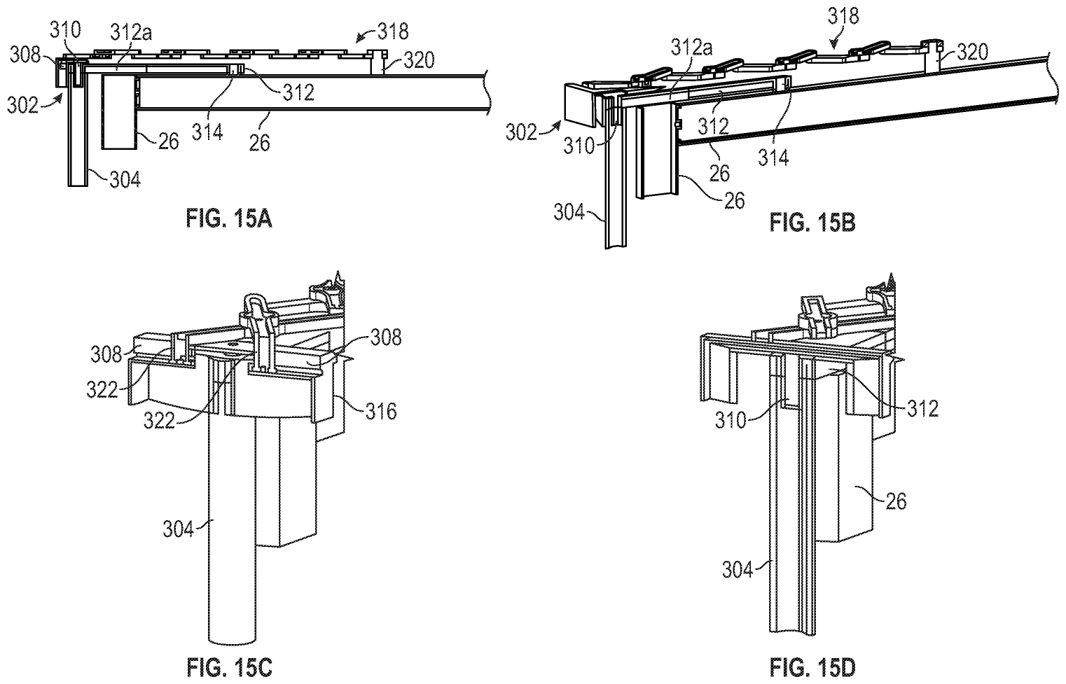

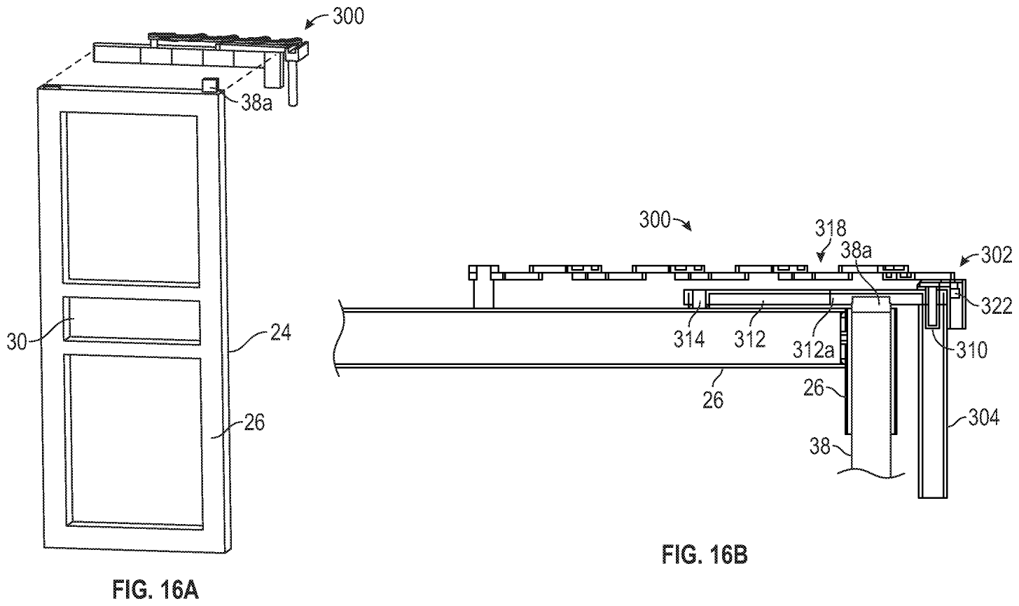

Referring now to FIGS. 14-17D, there is illustrated an embodiment of a support and hinge system, shown generally at 300, for supporting and swinging a balanced door system. The support and hinge system 300 permits a door to swing within an opening without undue forces, such as wind or internal air pressure differentials—interior stack pressure, causing difficult or accelerated motions of the door. As is known with balanced door systems, the pivoting point is moved from the outer door edge, where a conventional hinge element is typically mounted, to a selected location inboard of the outer edge. Traditional balanced door systems rely on a track and engaged rolling elements to guide the upper part of the door frame, such as door frame 26. The support and hinge system 300 includes a support mount 302 having a mounting post 304 and an upper guide member 306. The mounting post 304 may be secured to a building structure and may extend along the height dimension of a door frame (not shown). The upper guide member 306 includes guide tracks 308 and a pivot point 310. An upper pivot arm 312 is connected at a first end to the pivot point 310 and at a second end to a door pivot 314. The upper pivot arm 312 may include a striker 312a, shaped to receive the latch bolt 38a in order to secure the door in a closed position, as shown in FIG. 16B. A similar lower pivot arm (not shown) may be mounted between the lower outer portion of the door frame 26 and the post 304. The lower pivot arm may be similarly shaped as the upper pivot arm, including having a striker for accepting a lower extending latch bar and bolt, though the lower arm may be more substantial in size, particularly the thickness, to bear the weight and reaction loads of the door. The support mount 302 may also include a stop abutment 316 that contacts one or more of the upper pivot arm 314 and/or the door frame 26 in order to prevent over angulation of the door in an opened position.

A guide link, shown generally at 318 and configured as an accordion or scissor-type linkage, includes a guide pivot 320 attached to the door frame 26 at a distal end and a pair of opposing guide rollers 322 at a proximal end that engage the guide tracks 308 of the support mount 304. A plurality of scissor links 324 are interconnected by end pivots 326 and center pivots 328. The guide link 318 includes terminal links 330 that connect to the guide pivot 320. The scissor links 324 at the proximal end of the guide link 318 are connected to the guide rollers 322. The guide link 318 may include any number of scissor links 324 in order to span the necessary length of the upper door frame in order to guide the door and prevent binding of the support and hinge system 300.

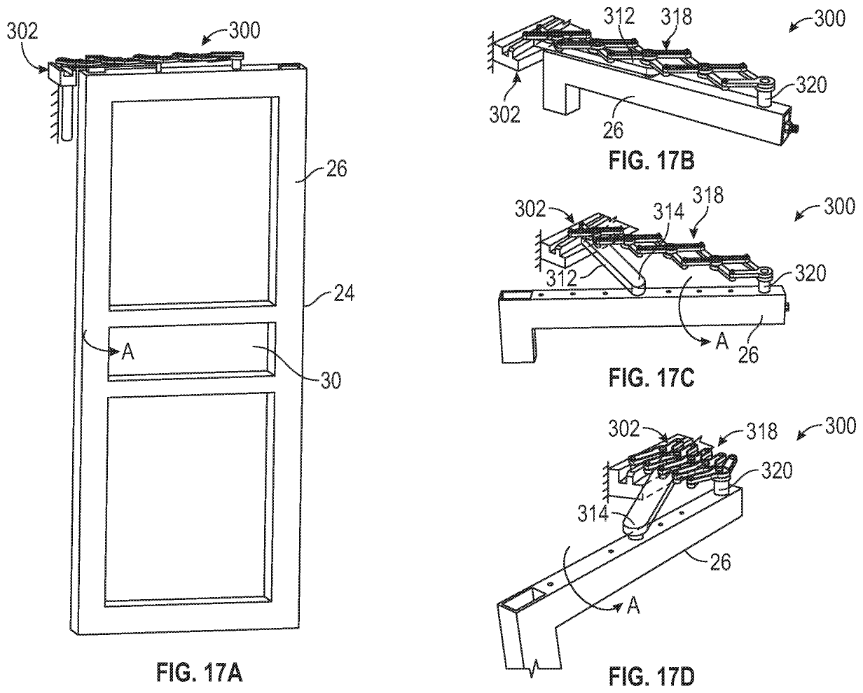

Referring now to FIGS. 17A-17D, there is illustrated one embodiment of the door 24 and support and hinge system 300 showing an opening and/or closing movement. The sequence will be described in conjunction with an opening movement where the door 24 is opened by actuating the touch bar 30 and pushing on the right side in order to generate a counterclockwise movement of the hinge or frame side of the door shown by arrow A. It should be appreciated that the door 24 is capable of swinging in either direction. The touch bar 30 retracts the bolt 38a from the striker 312a to permit movement of the door 24 and the support and hinge system 300. As the door is pushed on the right side, opposite the side connected to the support mount 302, the latching side pivots toward the user as the upper pivot arm 312 and the guide pivot 320 pivot. The guide link 318 stabilizes the door frame 26 as the door is drawn toward the support member and the outer door frame, shown by the ground symbol in FIGS. 17A-17D. The scissor construction permits the guide link 318 to retract in a compact manner.

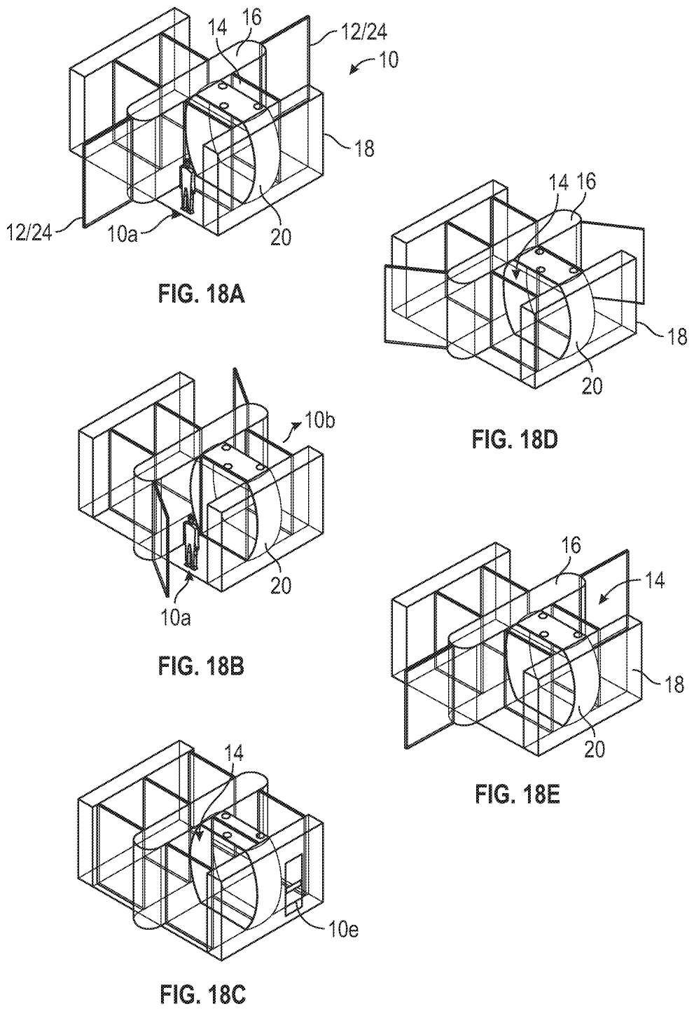

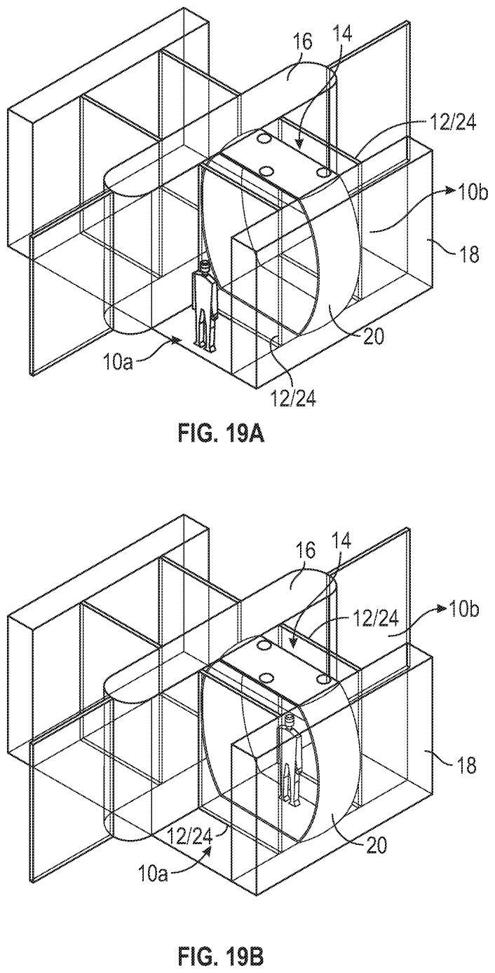

Referring now to FIGS. 18A-18E, there is illustrated a door or panel movement sequence of the entryway system 10. FIGS. 19A and 19B illustrate the interaction of the threat detection system 20 and the panels 12 or doors 24, when so fitted. The doors 22, in conjunction with the panels 12, or framed doors 24 may be of a balanced door construction and may optionally include the support and hinge system 300, described above. The entryway system 10 may be provided as an entrance and exit for a building or as an interior screening area. A person seeking admission enters the pre-security entrance 10a and the partitions/doors 12/24 rotate in unison around the central conveyor 16. As two adjacent partitions move proximate to the wall 18, the security vestibule 14 is created in conjunction with the threat detection system (or scanner) 20, as shown in FIGS. 19A and 19B. If the scanner 20 does not detect a threat condition or detects the presence of an authorized person, such as by RFID or facial recognition for example, with proper credentials and a scan suitable with those credentials, the partitions/doors continue to move permitting the user to move to the post-security exit 10b and enter.

While in the scanner 20, door rotation may stop or slow and the door 22, 24 in front of the user is handed to a non-actuation position, as presented to the user, such that exit from the security vestibule 14 through to the post-security exit is not possible. During the same time interval, the door 22, 24 behind the user (between the user and the pre-security entrance 10a) is handed opposite of the vestibule door in front of the user. The door 22, 24 behind the user is handed in an actuation position, as presented to the user, such that the user may exit back to the unsecured area and handed in a non-actuation position so no other person may enter the security vestibule 14. This condition prevents entrapment in the security vestibule 14 but prevents entry into the secured area. Alternatively, the entryway system 10 may be arranged with an additional door 10e to shuttle a user who fails the scan to another secured area without permitting entry through the post-security exit 10b. Such an additional side exit 10e permits more rapid user check-in when threats are detected and may be configured to be re-handed either remotely or by security personnel.

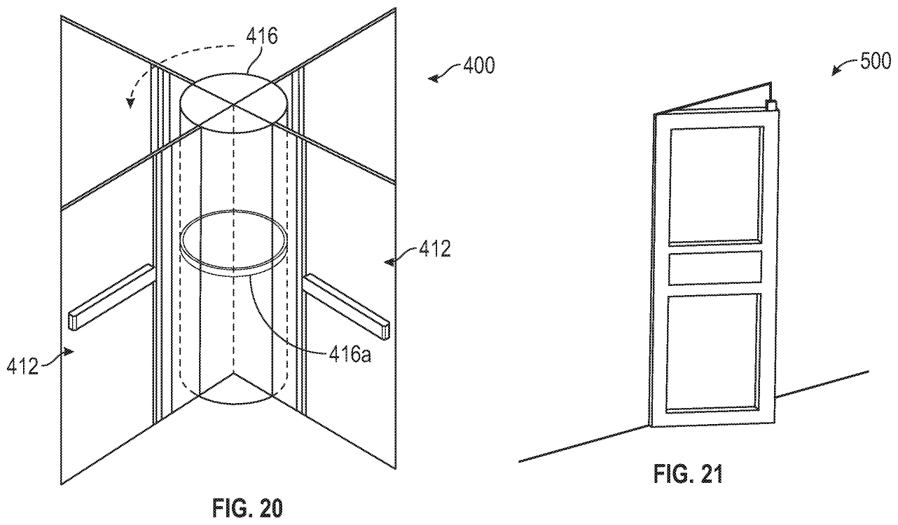

Referring to FIG. 20, there is illustrated another environment for use with the entryway system and threat detection system of the invention, configured as a circularly revolving door 400. The revolving door is illustrated having four doors 412, configured similarly to the partitions/doors 12/22 or the doors 24 described above. A center post 416 supports a handing trigger 416a that operates similarly to handing triggers 16a or 116a, described above. The rotation of the revolving door 400 is generally counterclockwise, similar to the conveyor 16 described above, though a clockwise rotation would work similarly. Referring to FIG. 21, there is illustrated a single hinged door 500 having either a conventional hinge arrangement secured to a door frame or a balanced door mount as described above. The handing of door 500 can be remotely actuated electronically or by an entry scan, such as a card, RFID, facial recognition, retina scan or the like.

The principle and mode of operation of this invention have been explained and illustrated in its preferred embodiment. However, it must be understood that this invention may be practiced otherwise than as specifically explained and illustrated without departing from its spirit or scope.

What is claimed is:

1. An entryway system comprising:
two spaced-apart walls;
a first partitioning element supporting a latching mechanism and extending between the two spaced-apart walls, the first partitioning element comprising:
a first access hardware selectable between a first handing position for actuating the latching mechanism to permit one of ingress or egress and a second handing position preventing actuation of the latching mechanism, and
a second access hardware opposite the first access hardware and providing the other of the first and second handing positions of the first access hardware;
a second partitioning element supporting a latching mechanism and extending between the two spaced-apart walls, the second partitioning element comprising:
a first access hardware selectable between a first handing position for actuating the latching mechanism to permit one of ingress or egress and a second handing position preventing actuation of the latching mechanism, and
a second access hardware opposite the first access hardware and providing the other of the first and second handing positions of the first access hardware;
the first and second partitioning elements defining a security vestibule and being responsive to a sensed condition, and wherein the second access hardware of the first partition faces the security vestibule and the sensed condition causes the second access hardware to be re-handed to the first handing position and the first access hardware of the second partitioning element faces the security vestibule and the sensed condition causes the first access hardware to be re-handed to the second handing position.

2. The entryway system of claim 1 wherein the position of the security vestibule generates the sensed condition and the second access hardware faces a post-security entrance into one of a building or a secured area.

3. The entryway system of claim 2 wherein the first and second access hardware are first and second touch bars connected to a latch actuation mechanism and a re-handing mechanism configured to select one of the first or second handing positions in response to a handing trigger.

4. The entryway system of claim 1 wherein the first and second partitioning elements are supported on a first side for relative rotation about a central conveyor system extending generally parallel between the two walls, the central conveyor system defining a rotating passageway direction.

5. The entryway system of claim 4 wherein the first and second partitioning elements are partitions, each partition supporting a door having the first and second access hardware and the latching mechanism.

6. The entryway system of claim 4 wherein the first and second partitioning elements are doors having a frame, each door having the first and second access hardware configured as first and second touch bars.

7. The entryway system of claim 4 wherein the central conveyor includes a handing trigger, and the sensed condition is a first sensed condition triggered by the handing trigger based on the position of the first and second partitioning elements relative to the security vestibule.

8. The entryway system of claim 7 wherein the first and second partitioning elements are doors having a frame, each door having the first and second access hardware configured as first and second touch bars, and the security vestibule includes one or more of a metal detector, an RFID reader, a facial recognition sensor, a x-ray device, an optical retinal scanner, a finger print analyzer, or a weight measurement device and a second sensed condition is triggered by the security vestibule to cause at least one of the rotation of the first and second doors about the central conveyor to stop or triggering of an alarm.

9. The entryway system of claim 7 wherein the first and second partitioning elements are doors having a frame, each door having the first and second access hardware configured as first and second touch bars, and the handing trigger is a mechanical handing trigger having spaced apart rails and the first access hardware of each door includes a re-handing mechanism, one handing trigger rail is configured to actuate the re-handing mechanism to the first handing position and the other rail is configured to actuate the re-handing mechanism to the second handing position.

10. The entryway system of claim 9 wherein the first sensed condition is the relative laterally extended position of one rail to the other rail, and the re-handing mechanism actuates the first handing position of both doors on the same side of the central conveyor as the security vestibule, the security vestibule including one or more of a metal detector, an RFID reader, a facial recognition sensor, a x-ray device, an optical retinal scanner, a finger print analyzer, or a weight measurement device and a second sensed condition is triggered by the security vestibule to cause at least one of the rotation of the first and second doors about the central conveyor to stop or triggering of an alarm.

11. The entryway system of claim 10 wherein the re-handing mechanism is mechanically coupled to one of a pair of touch bars at a trigger actuation end and a reaction support end, the trigger actuation end contacting at least one of the rails and responding to the first sensed condition.

12. The entryway system of claim 7 wherein the handing trigger is an electronic handing trigger and the re-handing mechanism includes one of a pneumatic, hydraulic, electromagnetic, or rack-and-pinion actuator, the re-handing mechanism includes a sensor in electronic communication with the electronic handing trigger to operate the re-handing mechanism and the first sensed condition is an electronic signal.

13. The entryway system of claim 12 wherein the re-handing mechanism actuates the first handing position of both doors on the same side of the central conveyor as the security vestibule, and the security vestibule triggers a second sensed condition to cause at least one of the rotation of the first and second doors about the central conveyor to stop or triggering of an alarm.

14. The entryway system of claim 7 wherein the first and second partitioning elements are balanced doors having a frame and a support and hinge system, each door having the first and second access hardware configured as first and second touch bars and the support and hinge system including a scissor-type guide linkage.

15. The entryway system of claim 14 wherein the support and hinge system includes a support mount and an upper guide member, the upper guide member includes guide tracks that engage a proximal end of the scissor-type guide linkage and a guide pivot that connects between a distal end of the scissor-type guide linkage and the door frame.

16. An entryway system comprising:
a support structure;
at least two doors configured as balanced doors, each door having a frame supported by the support structure and configured to swing relative to the support structure, the frame supporting a latch and a latch actuation mechanism between first and second touch bars; and
a support and hinge system having an upper guide member, the upper guide member includes guide tracks that engage a proximal end of the scissor-type guide linkage and a guide pivot that connects between a distal end of the scissor-type guide linkage and the door frame.

17. The entryway system of claim 16 wherein the upper guide member is connected to a mounting post, the mounting post pivotally supporting one end of an upper pivot arm and the door frame pivotally connected to the other end of the upper pivot arm.

18. The entryway system of claim 17 wherein the upper pivot arm includes a striker that engages a latch bolt end of the latch to secure the door from opening and the latch actuation mechanism disengages the latch bolt from the pivot arm to permit opening.

19. The entryway system of claim 17 wherein the support structure is a center support structure and the doors are supported for movement along the center support structure.

20. The entryway system of claim 19 wherein a re-handing mechanism is connected between the touch bars or to the latch actuation mechanism, the re-handing mechanism being responsive to a handing trigger to move one of the touch bars to an actuation position that operates the latch mechanism and the other touch bar to a non-actuation position that prevents operation of the latch mechanism.
